(19) United States
(12) Patent Application Publication
(10) Pub. No.: US 2019/0217670 A1
(43) Pub. Date: Jul. 18, 2019

(54) Total Tube Protector Tire Liner

(71) Applicant: Kurt E. Hurst, Phoenix, AZ (US)

(72) Inventor: Kurt E. Hurst, Phoenix, AZ (US)

(21) Appl. No.: 15/872,874

(22) Filed: Jan. 16, 2018

(51) Int. Cl. B60C 19/12

(52) U.S. Cl. CPC B60C 19/127; B60C 2005/145

(57) ABSTRACT

Tire exterior surface area is typically 33% tire tread and 67% tire sidewalls.

Current market availability products are inner tube sealants requiring scheduled replacement and seal a maximum ⅛ inch puncture and flat polyurethane tire liner puncture resistance for less than 33% of tire surface tread area only.

Typical pair of polyurethane tire liners 2-½ inches wide with inner tube sealant, retail cost $35 for 33% tire surface tread only. The present invention 5 inches wide, maximum protection, with inner tube sealant, retail cost is lower for 100% tire surface tread and sidewalls

Pair flat polyurethane tire liners 4.1 inches wide with inner tube sealant, retail cost over $75 for 33% tire surface tread only. The present invention 7 inches wide, maximum protection, with inner tube sealant, retail cost much lower for 100% tire surface tread and sidewalls

### CROSS-REFERENCE TO RELATED APPLICATIONS

| | | | |
|---|---|---|---|
| 6,105,642 | August 2000 | Carsen et Al. | 152/203 |
| 5,785,779 | July 1998 | McGee et Al. | 152/204 |
| 6,877,537 | April 2005 | Crow | 152/207 |
| 6,418,991 | December 1999 | Trice | 152/905 |
| 6,568,443 | May 2003 | Shoner | 152/157 |
| 4,303,114 | December 1981 | Price | 152/192 |
| 4,263,074 | April 1981 | Price | 156/110 |
| 4,231,407 | November 1980 | Jame | 152/351 |

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A “SEQUENCE LISTING,”

Not Applicable

### BACKGROUND OF THE INVENTION

### 1. Field of the Invention

The present invention relates to the field of wheels and pneumatic tires using an inflatable inner tube, and more particularly, inner tube puncture protection with a tire liner.

### 2. Description of the Prior Art

Puncture protection technology for pneumatic tires has significantly increased in both materials and processes; however, those costs have increased as well. Tubeless pneumatic automotive tire buyers expect durability and puncture protection and higher prices are expected as well.

To keep lower costs recreational and utility tire manufacturers have not kept pace with automotive. Pneumatic tires with inner tubes are typically used by motorcycles, cruisers, trikes, motor dirt bikes, mopeds, scooters, all terrain vehicles, utility ATV (All Terrain Vehicle), electric carts, recreational, bicycles, road bikes, sport, utility, riding mowers, hand truck, construction job site trailers even wagons and wheelbarrows. Common puncture hazards include city street debris, debris concentration along road edges, botanical thorns, cacti and goatheads (Thorny Weed), plus man made debris off road and on trails.

All pneumatic tires have thick tread 33% of surface area and thin sidewalls 67% of surface area. Current puncture protection focus on the tread area only and include Kevlar layers in tire manufacturing, solid inner tubes, heavy rubber inflatable tubes, tire sealants, permanent molding vulcanized rubber in owner's tire, extruded foam permanent molded, cellular trapped air, tight woven fabric backed with plastic with vulcanized rubber, aluminum wrapped in polyurethane tape, and polyurethane tire liners.

The two most common used products for inner tube puncture protection are liquid sealants installed inside inner tube; polyurethane tire liners installed between tire and inner tube covering approximately 33% of exposed tire surface. Sealants protect 100% inner tube surface and effectively seals the puncture area of ⅛ inch or less. Sealants must be regularly purged and replaced. Polyurethane tire liner flat strips protect only the tread area approximately 33% of exposed tire. A sharp object will penetrate polyurethane. Attempts to mitigate puncture depth by long sharp objects, polyurethane tire liners are made thicker and more costly. A pair of thicker polyurethane tire liners greater than 4″ in width exceed a cost of $100.

Current market availability, tire inner tube sealants and tire liner puncture protection for 33% of tire surface tread only. Inner tube replacement or repair is standard procedure and an accepted inconvenience.

### BRIEF SUMMARY OF THE INVENTION

The present invention shape is circular and semi spherical conforming to the interior tire surface area inclusive of sidewalls and tread with a consistent level of inner tube puncture protection across 100% of tire surface less a required setback from tire bead to not encumber tire installation and removal.

The present invention is comprised of a cut and formed solid non fiberglass fiber reinforced thermoplastic polymer layered with polyethylene on woven fabric with rubber adhesives. The present invention grips the interior tire surface and inner tube surface with no increased wear on the tire or inner tube and is recyclable.

The present invention increases protection surface area from current 33% to 100%, with solid inner tube puncture protection, not limited by tire widths, designed for automated process manufacturing, for a cost below current market limited offerings.

### BRIEF DESCRIPTION OF THE DRAWINGS

FIG. 1 Perspective View of the Embodiment of the Invention, Tire Edge to Interior Tire Surface

FIG. 2 Perspective View of the Embodiment of the Invention Cross-Sectional View in Motorcycle Tire

FIG. 3 Perspective View of the Embodiment of the Present Invention Front and Side Views

### DESCRIPTION OF THE PREFERRED EMBODIMENT

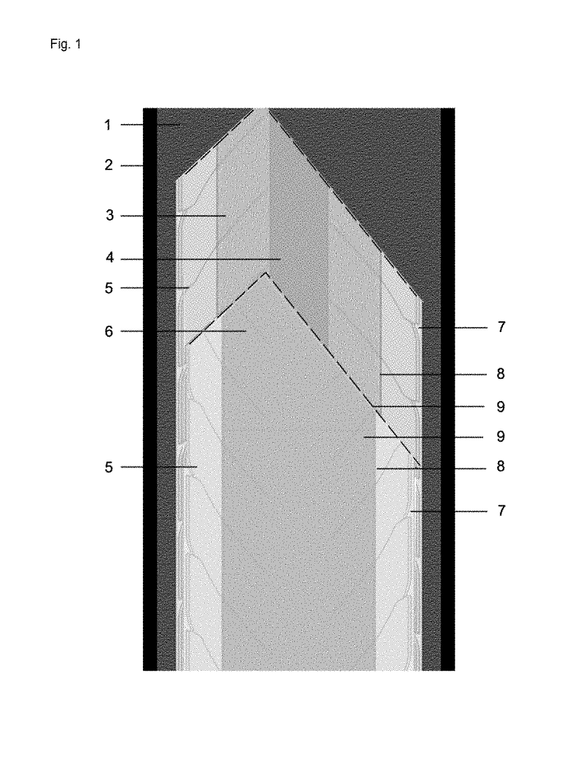

FIG. 1 Perspective View of the Embodiment of the Invention Double Layer, Tire Edge to Interior Tire Surface
1. Tire Interior Surface
2. Tire Bead
3. Layer 1 of 2 of the Present Invention
4. Strip of Polymer based elastic adhesive binding Layers 1 and 2 of the Present Invention.
5. Angular Reliefs of the Present Invention overlap and flex with tire and inner tube movement, covered on both sides with a Polyethylene film laminated to cloth with a rubber adhesive thickness approximately 7.6 mils.
6. Layer 2 of 2 of the Present Invention
7. In the Present Invention manufacturing process after Angular Reliefs are Made and prior to forming of Layers 1 and 2 with Polyethylene film laminated to cloth with a rubber adhesive rolled over Edge of Angular Relief Cuts.
8. In the Present Invention manufacturing process overlapping the process in item 7 on Layer 1 facing Tire Surface and Layer 2 Facing Bonding Surface with a Solid polymer polyethylene and polypropylene resin film laminated to strong woven scrim, thickness approximately 17 mils.
9. In the Present Invention manufacturing process overlapping items 7 and 8, after the Shape Forming process on Layer 1 facing Bonding Surface and Layer 2 Facing Inner Tube Surface a Solid polymer polyethylene and polypropylene resin film laminated to strong woven scrim, thickness approximately 17 mils.

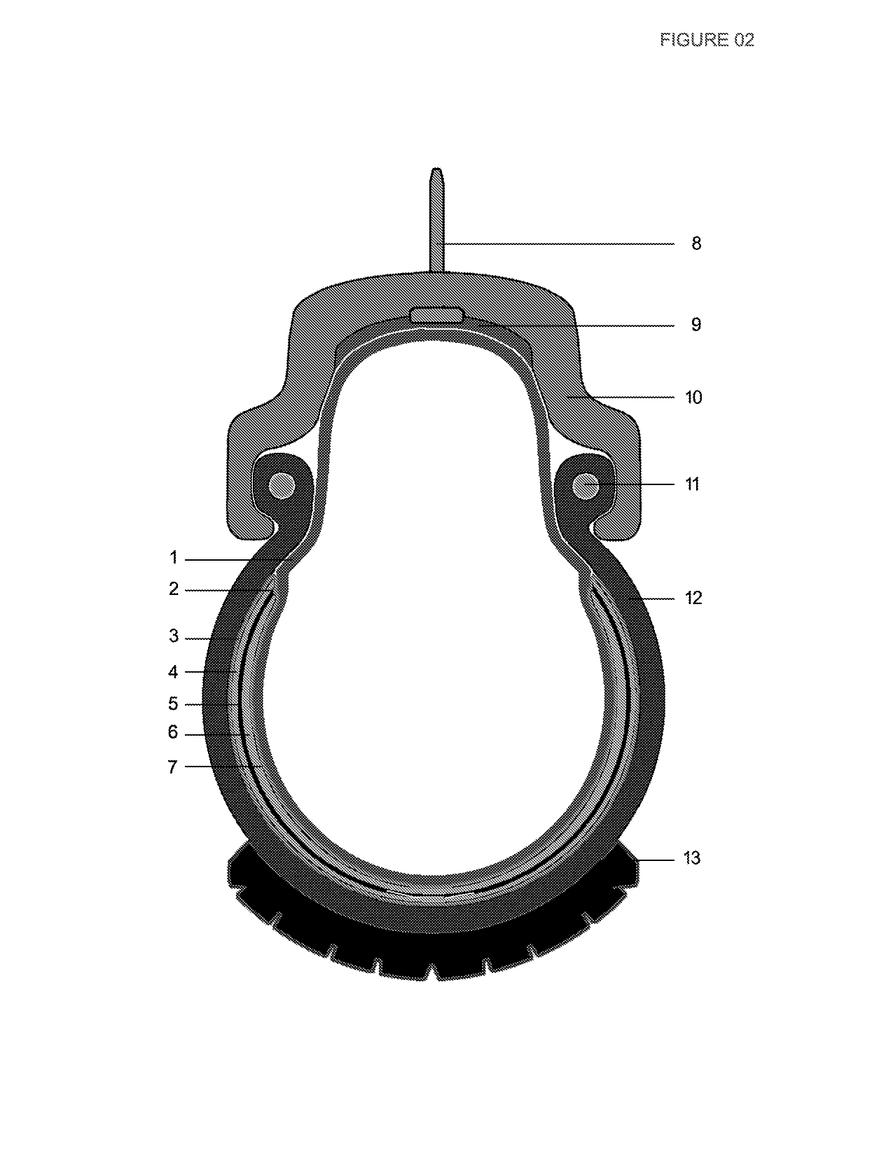

FIG. 2 Perspective View of the Embodiment Double Layer of the Invention Cross-Sectional View in Motorcycle Tire
1. Inner Tube
2. Embodiment of Present Invention installed between Interior Tire surface and Inner Tube.
3. Attached to Layer 1 Tire Surface Side of the Present Invention: Polyethylene film laminated to cloth with a rubber adhesive thickness approximately 7.6 mils and a Solid polymer polyethylene and polypropylene resin film laminated to strong woven scrim, thickness approximately 17 mils.
4. Embodiment of Present Invention Layer 1 of 2 Non Fiberglass Fiber Reinforced Thermoplastic Polymer
5. Attached to each Layer 1 and Layer 2 Bonding Surface Sides of the Present Invention: Polyethylene film laminated to cloth with a rubber adhesive thickness approximately 7.6 mils, Solid polymer polyethylene and polypropylene resin film laminated to strong woven scrim thickness approximately 17 mils, and a Polymer Based Adhesive Strip.
6. Embodiment of Invention Layer 2 of 2 Non Fiberglass Fiber Reinforced Thermoplastic Polymer
7. Attached to Layer 2 Inner Tube Surface Side of the Present Invention: Polyethylene film laminated to cloth with a rubber adhesive thickness approximately 7.6 mils. Solid polymer polyethylene and polypropylene resin film laminated to strong woven scrim, thickness approximately 17 mils.
8. Wheel Spoke
9. Rubber Layer between Wheel Spoke and Inner Tube.
10. Wheel Alloy Metal
11. Tire Bead
12. Tire Casing Sidewall: 67% of Area exposed to Potential Hazard Penetration
13. Tire Casing Tread: 33% of Area exposed to Potential Hazard Penetration

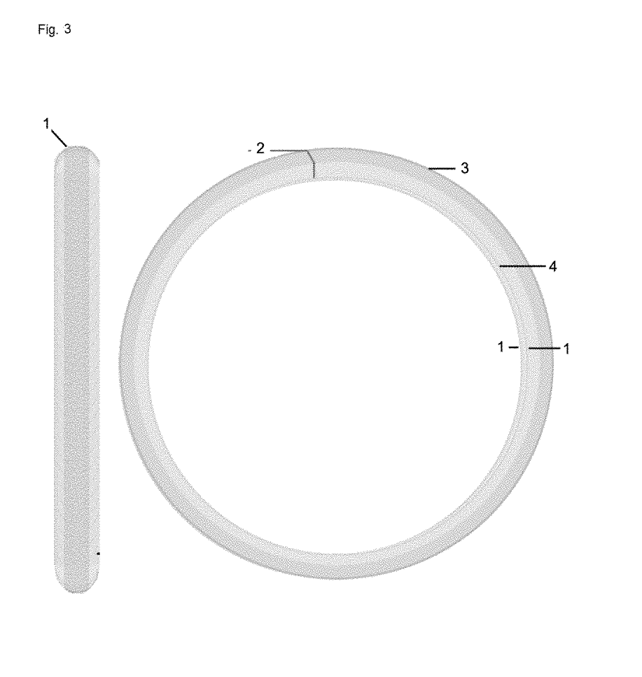

FIG. 3 Perspective View of the Embodiment of the Present Invention Front and Side Views
1. The Present Invention would be manufactured on a width basis measured by circumference from Tire Bead across Tire Interior to parallel Tire Bead Location. This measurement can be calculated based on Tire Type and Tire Information within 97% with required setback back from the tire bead to not encumber tire removal or installation on the wheel.
2. The present invention is very flexible and easy to install between the tire and inner tube; when installed there will be an end to end 180degree offset overlay between layers which allows flexibility for full tire and inner tube compression to wheel rim.
3. The Present Invention can be manufactured to fit a 36 inch tire diameter and 16 inch tire width; with a total 1.38 inch protection layer; however, typical dimensions will be less.
4. The Present Invention total thickness will vary determined by Tire Width, Type, Application and Operating Speed.:
   1. 0.15 Single 0.09 Layer, City Bicycle
   2. 0.22 Double 0.062 Layer, Off Road Trails Bicycle
   3. 0.21 Single 0.125 Layer, 3 Wheel Bicycle
   4. 0.29 Double 0.090 Layers, Dirt Bike
   5. 0.235 Single 0.125 Layer, ATV Utility
   6. 0.33 Double 0.125 Layers, Wheel barrows, Construction Trailer Tires
   7. 0.90 Double 0.375 Layers, 500 cc +Motorcycles

### DETAILED DESCRIPTION of INVENTION

Introduction

The present invention is comprised of cut and thermally formed non fiberglass fiber reinforced thermoplastic polymer each layer is covered with polyethylene film laminated on woven fabric with rubber adhesives covering angular relief cuts, and polypropylene and polyethylene resins laminated on strong woven scrim with rubber adhesives covering center of layers and overlapping angular relief cuts. Double layers are offset 180 degrees then bound together with a polymer based elastic adhesive

Rated 51 Shore D Min for Material 0.090 Inch Thick:

| | | |
|---|---|---|
| Strengths | 75,000 psi Flexural | 5000 psi Compressive |
| | 1100 psi Tensile | 2900 psi Shear |

The present invention grips the interior tire surface and inner tube surface with no increased wear on the tire or inner tube and is recyclable. The present invention covers 100% of interior tire surface less nominal set back from tire edge and bead for unencumbered tire installation and removal; conforms and completely protects inner tube from puncture hazards entering exterior tire surface sidewalls and tread areas.

The invention's annular curve, formed semi-spherical curve with edge angular reliefs use rigidity and flexibility to mitigate penetration force of sharp objects. Threats stopped by the invention include but limited to the following: sharp botanical cacti needles including jumping cholla, goatheads, thorns, man made needles, razors, knives, glass, metal or glass shards, screws, barbed wire and nails.

The invention flexes with the tire and inner tube and withstands full compression of the tire and inner tube to the wheel rim when hitting a hard surface directly such as a trail rock or street curb.

Manufacturing
Preferred Methods of Manufacturing Equipment and Processes will Vary.
The following is an Automated Continuous Feed Line Manufacturing Approach:
   1. Non Fiberglass Fiber Reinforced Thermoplastic Polymer Material on Supply Line unwind over Low Level Preheat
   2. Cutting, Product Marking and Forming
      a) High Speed Rolling Drum Knives Cut Product Widths, Angular Reliefs with Sculpted Edges and rounded Ends
      b) Polyethylene on Woven Fabric with Rubber Adhesive Layer applied over Angular Reliefs and rolled over Edges,
         1. Optional Colored Polyethylene
         1. Left Color, Product Width Visual Identification
         2. Right Color, Product Thickness Visual Identification
      c) Rolled Across and Pressed against Heated Stationary Semi Spherical Form Applying Concave Side Polypropylene and Polyethylene on Strong Woven Fabric Layer.
         1. Optional Colored or Printed Logo and Brand Identification
      d) Rolled Across and pressed against Cooled Stationary Circular Form. With Polyethylene Strong Woven Fabric Layer applied to Convex Side.
         1. Optional Colored or Printed for Quick Visual Identification
      e) Part Marking and Manufacturing code applied
   3. Packaging
      a) Rolled, Packaged, Labeled, boxed on pallet and sent to distribution.

I claim:

1. The present invention is placed between the interior tire surface and inner tube of any pneumatic tire, to stop a forced penetration of any sharp object from passing through the tire from any angle including tire sidewalls and tread areas, without puncturing the inner tube.

2. The present invention as claimed in 1 is designed for maximum protection, easy user installation and low cost automated manufacturing utilizing a combination of low cost recycled thermally formed non fiberglass fiber reinforced thermoplastic polymers, polymer based elastic adhesive, and polypropylene and polyethylene resins laminated on strong woven scrim with rubber adhesives.

3. The present invention as claimed in 1 can be used as a single layer for low speeds or double layers for maximum protection of all botanical cacti needles, inclusive of jumping cholla, goatheads, thorns, man made needles, razors, knives, glass, metal or glass shards, screws, barbed wire and nails.
